(19) United States
(12) Patent Application Publication
(10) Pub. No.: US 2026/0347701 A1
(43) Pub. Date: Nov. 5, 2026

(54) COMPOSITION TO IMPROVE CENTRIFUGATION EFFICIENCY IN THE RENDERING PROCESS

(71) Applicant: Héctor Rodrigo LATORRE SALAS, Santiago (CL)

(72) Inventor: Héctor Rodrigo LATORRE SALAS, Santiago (CL)

(21) Appl. No.: 19/195,127

(22) Filed: Apr. 30, 2025

(51) Int. Cl. C09K 23/38; C11B 1/10

(52) U.S. Cl. CPC C09K 23/38; C11B 1/10

(57) ABSTRACT

The present invention relates to a food grade anti-emulsifying composition that improves the efficiency of solids/oil separation during the rendering process (poultry, pork and beef by-products) and fishmeal and fish oil processes.

### FIELD OF THE INVENTION

The present invention relates to a technological composition, more specifically, to a food-grade anti-emulsifying composition that improves the efficiency of solids/oil separation during the rendering process (poultry, pork and beef by-products) and fishmeal and fish oil processes.

### BACKGROUND OF THE INVENTION

For several years now, the poultry, pork, and meat industries have been constantly expanding. Several factors contribute to this growth, including improved production efficiency and reduced production costs, which are a result of increased investment in technology throughout the chain. Likewise, the increased consumption of poultry, meat, pork, and aquaculture, and the trend toward lean, easy-to-prepare meats, are generating demand and constant development. While this growth has countless economic and productive advantages, it also poses the problem of a considerable increase in organic waste from this industry, primarily slaughter-derived waste such as feathers, viscera, and blood. Furthermore, they generate additional costs for companies as they must be transported daily outside the slaughterhouses. The production of feather, viscera, blood, and oil or fat meals is presented as an option to solve these problems. It also adds value to these by-products, which are used primarily as raw materials in the animal feed industry (flavorings and meals for pet food, meal for concentrates, aquaculture feed, etc.). This ensures the existence of a market for the by-products obtained.

The technology available for transforming organic waste into flours or oils with high availability of animal protein is technically simple. It generally involves physical hydrolysis processes, which aim to increase protein digestibility.

The demand for quality animal protein and fats or oils continues to increase in the pet food market and in the feed market in general. Therefore, planning and continuous innovation are the main challenges for the poultry by-product processing industry in the coming years.

The rendering process, which converts waste from the poultry, cattle, pork and/or aquaculture industries into by-products such as flour and oil, substances suitable for animal feed.

For example, the document RU2728468 has been described in the state of the art, which is related to the food and biotechnology industry, and its objective is to produce a highly digestible food-grade protein additive in the form of a water-soluble powder, which is obtained from meat and bone raw material with a high content of mineralized collagen, for example, beef bones. The raw meat and bone material is ground, homogenized in a liquid medium, thermohydrolyzed at a temperature of 150-170 °C and a pressure of 10-12 bars for 2-4 hours, cooled and fractionated, separating the protein-mineral sedimentary fraction, the liquid fat fraction and the protein. The resulting sedimentary protein-mineral fraction is subjected to enzymatic hydrolysis by adding an aqueous solution of a proteolytic enzyme with collagenase specificity in a sediment:solution ratio of 1:1-1:3, and the mixture is kept for 1-3 hours at a temperature of 35-45 °C, after which the mixture is heat treated at a temperature of 150-170 °C and a pressure of 10-12 bars for 2-4 hours, then cooled and fractionated with separation into fat, mineral substances and liquid protein fraction, which is connected to the liquid protein fraction obtained after thermal hydrolysis, after which the resulting mixture is concentrated and dried. There are no indications about adding any anti-emulsifiers to the centrifugation stage.

Another document is U.S. Pat. No. 7,763,717 (B1), which teaches a process and system for recovering proteins and lipids from food animal by-products and their products involves homogenizing animal by-products with water to form a homogenate, solubilizing the homogenate by adjusting the pH of the homogenate to form a first pH-adjusted composition, separating the first pH-adjusted composition forming a light fraction containing lipids (oil), a middle fraction containing protein in solution, and a heavy fraction containing non-fat impurities, separating by first centrifuging, adjusting the pH of the middle fraction to approximately the isoelectric point of the middle fraction thereby precipitating proteins to form a second pH-adjusted composition, and separating the second pH-adjusted composition forming a light fraction containing water and a heavy fraction containing precipitated proteins. The water may then be recycled and used in the homogenization of additional by-products.

However, none of the documents existing in the prior art describe a food-grade anti-emulsifying technological composition that improves the efficiency of solids/oil separation during the rendering process (poultry, pork and beef by-products) and fishmeal and fish oil processes.

### SUMMARY OF THE INVENTION

The present invention relates to a food grade anti-emulsifying composition that allows improving the efficiency in the separation of solids/oil during the rendering process (poultry, pork and beef by-products) and fishmeal and oil processes. Its formulation contains inorganic acids with an organic buffer regulated pH, more specifically, a formulation that allows increasing the extraction of final oil in the centrifugation stage (Decanter or tridecanter) in the rendering by-product meal process (poultry, pork, meat and aquaculture) and fishmeal and oil processes, increasing the oil yield and reducing the fat of the solid.

### DESCRIPTION OF THE FIGURES

FIG. 1 describes the mass balance at the centrifugation stage of the rendering process.

FIG. 2 describes the % Fat of the tallow over time. The % Fat is specified on the Y axis and the Timeline on the x axis, with the objective of demonstrating the effectiveness of the product when applied in the centrifugation stage, obtaining a solid with less fat and consequently an increase in oil yield. The test was carried out under normal or usual process operating conditions for one week, applying a dose of 1,000 ppm to the liquid entering the centrifuge.

FIG. 3 describes a graph of Fat with application vs Control or blank, detailing the normal distribution of fat in the lees (Gauss curve). The Y axis specifies normal distribution values and the X axis the Fat % values, with the aim of demonstrating the effectiveness of the product when applied in the centrifugation stage, obtaining a lower fat solid and consequently an increase in oil yield. The test was carried out under normal or usual process operating conditions for one week, applying a dose of 1,000 ppm to the liquid entering the centrifuge.

### DESCRIPTION OF THE INVENTION

The present invention is based on the development of a technological product, whose main objective is to be a food grade anti-emulsifier, which allows improving efficiency in the solids/oil separation during the rendering process.

This liquid product is formulated based on an organic tricarboxylic acid with a structure consisting of three carboxyl groups (COOH) and one hydroxyl group (OH), with a pH level between 3 and 6. Its composition accounts for less than 20% w/v of the final formula. It also contains a ternary compound classified as a weak acid and belongs to the oxoacid category. Its composition accounts for less than 70% w/v of the final formula.

This product has the chemical action of allowing the emulsion produced in the centrifugation process to be eliminated, generating a hydrolysis that separates the fat from the carbohydrates and proteins.

In the processes of flour and oil from poultry by-products, feathers, blood and meat, a solid/oil is obtained that is very difficult to separate, because the phases are miscible during the separation stage. Therefore, a centrifugation process is described within a rendering process, where the described product is applied before centrifugation of the oil obtained in the rendering.

This product is a liquid, formulated based on an organic tricarboxylic acid with a structure consisting of three carboxyl groups (COOH) and one hydroxyl group (OH), with a pH level between 3 and 6. Its composition accounts for less than 20% w/v of the final formula. It also contains a ternary compound classified as a weak acid and belongs to the oxoacid category. Its composition accounts for less than 70% w/v of the final formula.

The pH is stabilized with a buffer composed of inorganic and organic species such as hydrogen phosphate (HPO₄²⁻), dihydrogen phosphate (H₂PO⁴⁻) and propionate ion (C₃H₅O²⁻). This buffer is characterized by having pH ranges between 2-4 and whose ionic strength has been modified with a neutral salt. The composition of this buffer is less than 5% v/v of the total formulation. The dilution carrier corresponds to propylene glycol, glycerol and water, and its composition is qsp. 100%.

In one embodiment of the invention, an anti-emulsifying composition is described that allows increasing the extraction of final oil in the centrifugation stage in the rendering process, which comprises:
a. 10% to 20% w/v of an organic tricarboxylic acid whose structure corresponds to three carboxyl groups (COOH) and one hydroxyl group (OH),
b. 50% to 70% w/v of a ternary compound classified as a weak acid and belonging to the category of oxoacids,
c. 3% to 5% v/v buffer solution.
d. A dilution carrier corresponding to Propylene glycol, glycerol and water, qsp. 100%,
where the pH is 2.0+/−0.5 and the density is 1.70+/−0.05 g/ml.

The described composition is presented, where the organic tricarboxylic acid is citric acid and its sodium salt, trisodium citrate.

In another preferred embodiment, the above composition is described, where the ternary compound classified as a weak acid is phosphoric acid and its sodium salt, trisodium phosphate.

In another preferred embodiment, the above composition is described, where the buffer solution comprises organic and inorganic species, such as hydrogen phosphate (HPO₄²⁻), dihydrogen phosphate (H₂PO⁴⁻) and Propionate ion (C₃H₅O²⁻) and a neutral salt, such as sodium chloride.

In another preferred embodiment, a process is described for preparing the anti-emulsifying composition described above, comprising:
a. have a solution containing propylene glycol, glycerol and water,
b. add 10 to 20% w/v of an organic tricarboxylic acid,
c. add 50 to 70% w/v of a ternary compound classified as a weak acid,
d. Stabilize the pH by adding between 2 to 5% v/v of a buffer composed of inorganic and organic species and a neutral salt,
e. top up with water to reach 100%.

In another preferred embodiment, the above procedure is described where the pH is 2.0+/−0.5 and the density is 1.70+/−0.05 g/mL.

In another preferred embodiment, the above process is described, where the organic tricarboxylic acid is citric acid and its sodium salt, trisodium citrate.

In another preferred embodiment, the above process is described, where the ternary compound classified as a weak acid is phosphoric acid and its sodium salt, trisodium phosphate.

In another preferred embodiment, the above procedure is described, where the buffer solution comprises organic and inorganic species, such as hydrogen phosphate (HPO₄²⁻), dihydrogen phosphate (H₂PO⁴⁻) and propionate ion (C₃H₅O²⁻).

### Examples

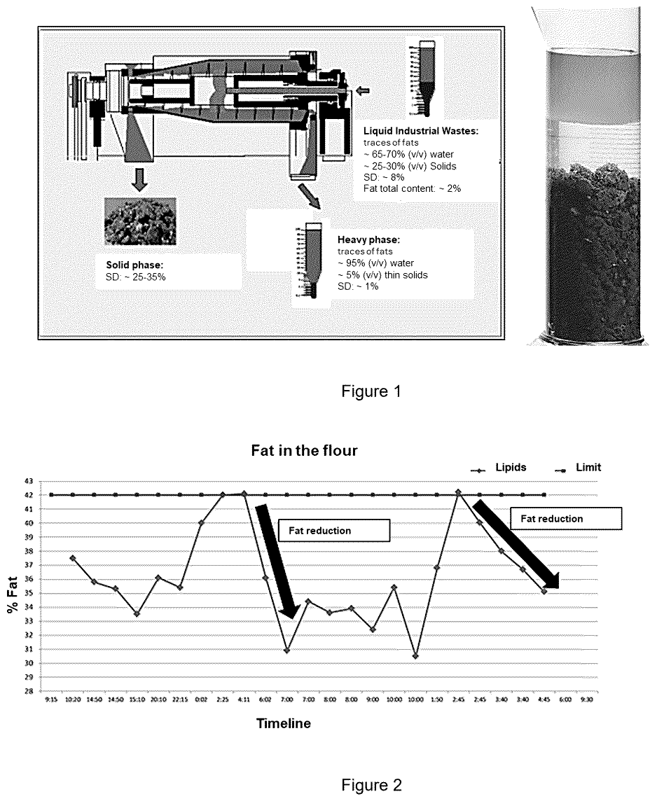

There is an anti-emulsifying composition, which can chemically separate the oil from the solid and is demonstrated by the present mass balance that summarizes the results at the pilot level in a plant, improving the % of fat of the solid skimmed with the technological product of the present invention in the rendering process. (see FIG. 1).

The diagram in FIG. 1 shows a centrifuge equipment, where the separation by solid phase (black color) and liquid phase (blue color) can be seen.

FIG. 1 shows Stage A, where the dirty oil from the rendering process enters the centrifuge. Table 1 shows the starting product concentrations from Stage A.

TABLE 1
Parameters before centrifugation.
Dirty oil

| F | 7,500 ^{m3}/hr | |
|---|---|---|
| SS | 35.00% | 2.625 kg/h |
| Water | 4.00% | 300 kg/h |
| O&G | 61.00% | 4.575 kg/h |

Where:
   F: Flow
   SS: Solid
   O&G: Oil and grease

Stage B in FIG. 1 represents the output of lees flour after centrifugation. Table 2 shows the solids concentrations obtained.

TABLE 2
Parameters after centrifugation.
Lees flour

| F | 4,300 ^{m3}/hr | |
|---|---|---|
| SS | 60.40% | 2.599 kg/h |
| Water | 6.60% | 282 kg/h |
| O&G | 33.00% | 1.419 kg/h |

Where:
   F: Flow
   SS: Solid
   O&G: Oil and grease

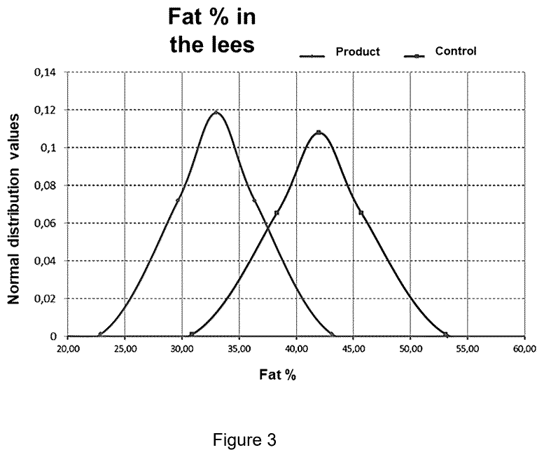

FIGS. 2 and 3 show the oil concentration obtained from the process. Table 3 shows the final oil concentrations, which demonstrate that the application of the composition of the present invention reduces the fat concentration in the decanter, used in the centrifugation stage of the rendering process.

FIG. 2 describes the % Fat of the tallow over time. The % Fat is specified on the Y axis and the Timeline on the x axis, with the objective of demonstrating the effectiveness of the product when applied in the centrifugation stage, obtaining a solid with less fat and consequently an increase in oil yield. The test was carried out under normal or usual process operating conditions for one week, applying a dose of 1,000 ppm to the liquid entering the centrifuge.

FIG. 3 describes a graph of Fat with application vs Control or blank, detailing the normal distribution of fat in the lees (Gauss curve). The Y axis specifies normal distribution values and the X axis the Fat % values, with the aim of demonstrating the effectiveness of the product when applied in the centrifugation stage, obtaining a lower fat solid and consequently an increase in oil yield. The test was carried out under normal or usual process operating conditions for one week, applying a dose of 1,000 ppm to the liquid entering the centrifuge.

TABLE 3
Final oil concentrations.
Lees flour

| F | 3,200 ^{m3}/hr | |
|---|---|---|
| SS | 0.80% | 26 kg/h |
| Water | 0.60% | 18 kg/h |
| O&G | 98.60% | 3.156 kg/h |

Where:
   F: Flow
   SS: Solid
   O&G: Oil and grease

In summary, the values achieved with the application of the product of the present invention are the following:

TABLE 4
Values achieved with the application of
the product of the present invention.

| | White | Product |
|---|---|---|
| | 42% | 33.00% |
| Oil Production (m³/hr) | 2.533 | 3,200 |
| Higher Oil Production (m³/hr) | | 667 |
| Higher Performance | | 2.94% |

In view of the foregoing, those skilled in the art will understand that changes can be made to the specific aspects described and still obtain the same or similar results without departing from the spirit and scope of the invention. Therefore, the specific functional and structural details described herein should not be construed as exhaustive. It should be understood that the entire description of each reference cited herein is incorporated into the description of the present application.

While this invention has been described in the embodiments set forth above, it may seem obvious that other alternatives, modifications, or variations would yield the same results; however, we have been able to determine that the subject matter described in this application is fundamental to the success of the invention described. Consequently, the embodiments of the invention are intended to be illustrative, not limiting. Various changes may be made without departing from the spirit and scope of the invention as defined in the following claims.

All patents, patent applications, scientific articles and other public documents that, to the applicant's knowledge, constitute the state of the art have been duly cited in this application.

1. An anti-emulsifying composition, wherein allows to increase the extraction of final oil in the centrifugation stage in the rendering process, which comprises:
a. 10% to 20% w/v of an organic tricarboxylic acid whose structure corresponds to three carboxyl groups (COOH) and one hydroxyl group (OH),
b. 50% to 70% w/v of a ternary compound classified as a weak acid and belonging to the category of oxoacids,
c. 3% to 5% v/v buffer solution, and
d. a dilution carrier corresponding to propylene glycol, glycerol and water, qsp. 100%,
where the pH is 2.0+/−0.5 and the density is 1.70+/−0.05 g/ml.

2. The composition according to claim 1, wherein the organic tricarboxylic acid is citric acid and its sodium salt, trisodium citrate.

3. The composition according to claim 1, wherein the ternary compound classified as a weak acid is phosphoric acid and its sodium salt, trisodium phosphate.

4. The composition according to claim 1, wherein the buffer solution comprises organic and inorganic species and a neutral salt.

5. The composition according to claim 1, wherein the buffer solution comprises hydrogen phosphate (HPO₄²⁻), dihydrogen phosphate (H₂PO⁴⁻) and Propionate ion (C₃H₅O²⁻) and sodium chloride.

6. A process for preparing the composition according to claim 1, wherein comprises the steps of:
a. have a solution containing propylene glycol, glycerol and water
b. add 10 to 20% w/v of an organic tricarboxylic acid,
c. add 50 to 70% w/v of a ternary compound classified as a weak acid,
d. stabilize the pH by adding between 2 to 5% v/v of a buffer composed of inorganic and organic species and a neutral salt,
e. add water to reach 100%.

7. The process according to claim 6, wherein the organic tricarboxylic acid is citric acid and its sodium salt, trisodium citrate.

8. The process according to claim 6, wherein the ternary compound classified as a weak acid is phosphoric acid and its sodium salt, trisodium phosphate.

9. The process according to claim 6, wherein the buffer solution comprises hydrogen phosphate (HPO₄²⁻), dihydrogen phosphate (H₂PO⁴⁻) and Propionate ion (C₃H₅O²) and sodium chloride.
